(19) United States
(12) Patent Application Publication
(10) Pub. No.: US 2014/0251786 A1
(43) Pub. Date: Sep. 11, 2014

(54) System for Harvesting Oriented Light for Carbon Dioxide Reduction

(71) Applicant: Sunpower Technologies LLC, (US)

(72) Inventors: Daniel Landry, Redondo Beach, CA (US); Travis Jennings, San Diego, CA (US)

(73) Assignee: Sunpower Technologies LLC, San Marcos, CA (US)

(21) Appl. No.: 13/793,383

(22) Filed: Mar. 11, 2013

(51) Int. Cl. B01J 19/12

(52) U.S. Cl. CPC B01J 19/127
USPC 204/157.15; 422/186

(57) ABSTRACT

A system and method for harvesting oriented light for reducing carbon dioxide to produce fuels, such as methane, are disclosed. The present disclosure also relates to oriented photocatalytic semiconductor surfaces that may include oriented photocatalytic capped colloidal nanocrystals (PCCN) which may form oriented photoactive materials. The disclosed photocatalytic system for harvesting oriented light may include a polarization system that employs reflective or polarizing surfaces, such as mirror surfaces for collecting solar energy, and orient the light rays for maximum absorption and energy conversion on oriented photoactive material. The photocatalytic system may also include elements necessary to collect and transfer methane, for subsequent transformation into electrical energy.

### CROSS-REFERENCE TO RELATED APPLICATIONS

The disclosure here described is related to the invention disclosed in the U.S. application Ser. No. (not yet assigned), entitled “Photocatalytic System for the Reduction of Carbon Dioxide”.

### BACKGROUND

1. Technical Field

The present disclosure relates to carbon dioxide (CO₂) reduction systems. In particular, the present disclosure relates to fuel generation systems in which light is harvested for the photo-catalytic carbon dioxide reduction.

2. Background Information

Various efforts have been done to seek new materials and/or novel structures for efficient solar energy conversions. To be economically competitive, solar energy needs to be converted into other forms that can be directly utilized with high efficiency and low cost.

One enticing topic in this broad endeavor is the photocatalytic reduction of carbon dioxide to various higher energy products so as to store solar energy as chemical energy and create renewable fuels. One advantage is the existing infrastructure which already supports the delivery of liquid fuels and natural gas, such as methane because it can be employed as a residential fuel, as an industrial fuel. Additionally, methane serves as a raw material for creating petrochemicals.

The principles of photocatalytic carbon dioxide reduction require high surface areas for electron excitation and collection, and the use of nanocatalysts with high surface to volume ratio is a favorable match. Semiconductor nanocrystals can improve photocatalysis through the combined effects of quantum confinement and unique surface morphologies.

Current nanocrystal-based photocatalytic devices suffer from inefficient charge transfer from the nanostructure surface to the electrode of the photocatalytic device. One limiting factor in the electron/hole transport is the degree of nanocrystal packing and ordering. Generally the nanostructures are produced in bulk as free-standing elements that must be positioned and/or oriented within the photocatalytic device, a task which has proven difficult. While a variety of procedures for making nanostructures are available, current technologies are insufficient to produce selectively-oriented or arranged arrays of nanostructures.

Surface and orientation modification of nanosized catalysts may be used to enhance the efficiency of light harvesting and may affect redox potentials. It has been demonstrated that the reflectivity could be optimized through tuning the geometry of the nanostructures in order to achieve a low reflectance in a specific wavelength range.

There is a need for development of photocatalytic devices which include selectively-oriented or arranged arrays of semiconductor nanostructures that may operate with high energy conversion efficiency for alternative fuel generation.

### SUMMARY

The present disclosure describes a photocatalytic system for harvesting oriented light that may be employed to reduce carbon dioxide for the production of fuels, such as methane. The disclosed photocatalytic system for harvesting oriented light employs oriented photocatalytic semiconductor surfaces as photoactive materials in order to reduce carbon dioxide. Photocatalytic semiconductor surfaces include oriented photocatalytic capped colloidal nanocrystals (PCCN). Oriented PCCN may be configured in arranged arrays and in different shapes such as tetrapod, spherical, core/shell, carbon nanotubes, and nanorods in order to enhance light harvesting. Subsequently, an application of orientation methods known in the art may be applied to the photoactive material.

In one aspect of the present disclosure, a method for producing PCCN may synthesize semiconductor nanocrystals and substitute organic capping agents with inorganic capping agents.

In one embodiment, in order to form oriented photocatalytic semiconductor surfaces oriented PCCN may be grown and deposited onto a suitable substrate by employing a variety of state of the art methods for semiconductor nanocrystal growth as well as for semiconductor nanocrystal deposition. Subsequently, an application of orientation forces by employing methods known in the art may be applied to the photoactive material. According to an embodiment, suitable substrates may be porous, which may have a pore size sufficient to admit CO₂ and H₂ gas. The oriented photoactive material may be placed inside a reaction vessel where carbon dioxide and hydrogen gas may be introduced. Light from a light source such as sunlight may enter in a specific direction, employing a polarization system, into the reaction vessel so that a redox reaction may take place between oriented photoactive material, carbon dioxide, and hydrogen.

When semiconductor nanocrystals in oriented photoactive material are irradiated with photons having a level of energy greater than band gap of oriented photoactive material, electrons may be excited from valence band into conduction band, leaving holes behind in valence band. Excited electrons may reduce carbon dioxide molecules into methane molecule, while holes may oxidize hydrogen gas molecules. Oxidized hydrogen molecules may react with carbon dioxide and form water and methane molecules via a series of reactions. Electrons may acquire energy corresponding to the wavelength of absorbed light.

Suitable light source may have a wavelength between about 300 nm and about 1500 nm. Polarization system within the disclosed photocatalytic systems may include various mirror surfaces in order to focus linearly polarized light and therefore increase the efficiency of the photocatalytic system by decreasing the active surface of oriented photoactive material needed for carbon dioxide reduction.

The methane gas produced employing the disclosed photocatalytic system, may be delivered as fuel for homes, businesses, and factories.

In one embodiment, a method for reducing carbon dioxide comprises: forming photocatalytic capped colloidal nanocrystals, wherein each photocatalytic capped colloidal nanocrystal includes a first semiconductor nanocrystal capped with a first inorganic capping agent; depositing the formed photocatalytic capped colloidal nanocrystals onto a porous substrate; orienting the photocatalytic capped colloidal nanocrystals; absorbing irradiated light with an energy equal to or greater than the band gap of the semiconductor nanocrystals by the photocatalytic capped colloidal nanocrystals to create charge carriers in a conduction band of the photocatalytic capped colloidal nanocrystals and holes in a valence band of the photocatalytic capped colloidal nanocrystals; reacting carbon dioxide and hydrogen with the photocatalytic capped colloidal nanocrystals so that the charge carriers in the conduction band reduce carbon dioxide into methane and the holes in the valence band oxidize the hydrogen into water vapor; and collecting the methane and water using a methane permeable membrane and a water vapor-permeable membrane.

In another embodiment, a carbon dioxide reduction system comprises: an oriented photoactive material, wherein the oriented photoactive material includes oriented photocatalytic capped colloidal nanocrystals; a reaction vessel housing the oriented photoactive material and configured to receive carbon dioxide from a first inlet, receive hydrogen from a second inlet, and facilitate a carbon dioxide reduction reaction and a hydrogen oxidization reaction that produces methane and water vapor, wherein the reaction begins when the photocatalytic capped colloidal nanocrystals absorb polarized light to separate charge carriers of the oriented photoactive material; and a collector comprising a methane-permeable membrane and a water vapor permeable membrane and configured to receive the produced methane and water vapor from the reaction vessel through an outlet line and separate and collect the methane and water vapor using the methane-permeable membrane and the water vapor permeable membrane.

In another embodiment, a carbon dioxide reduction system comprises: an oriented photoactive material, wherein the oriented photoactive material includes oriented photocatalytic capped colloidal nanocrystals; a boiler that produces carbon dioxide through a combustion reaction; a reaction vessel housing the oriented photoactive material and configured to receive carbon dioxide from the boiler through a first inlet, receive hydrogen from a second inlet, and facilitate a carbon dioxide reduction reaction and a hydrogen oxidization reaction that produces methane and water vapor, wherein the reaction begins when the photocatalytic capped colloidal nanocrystals absorb polarized light to separate charge carriers of the oriented photoactive material; and a collector comprising a methane-permeable membrane and a water vapor permeable membrane and configured to receive the produced methane and water vapor from the reaction vessel through an outlet line and separate and collect the methane and water vapor using the methane-permeable membrane and the water vapor permeable membrane.

Numerous other aspects, features of the present disclosure may be made apparent from the following detailed description, taken together with the drawing figures.

Additional features and advantages of an embodiment will be set forth in the description which follows, and in part will be apparent from the description. The objectives and other advantages of the invention will be realized and attained by the structure particularly pointed out in the exemplary embodiments in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

Embodiments of the present disclosure are described by way of example with reference to the accompanying figures which are schematic and not intended to be drawn to scale.

FIG. 1 is a flowchart of a method for forming a composition of PCCN, according to an embodiment.

FIG. 2 shows a nanorod configuration of PCCN, according to an embodiment.

FIG. 3 illustrates transition dipole moment characterization within PCCN in nanorod configuration, according to an embodiment.

FIG. 4 is a flowchart of a method for forming oriented photocatalytic semiconductor surfaces, according to an embodiment.

FIG. 5 depicts an alignment process employing electric fields, according to an embodiment.

FIG. 6 depicts an embodiment oriented PCCN in nanorod configuration showing oriented dipole moment receiving light.

FIG. 7 illustrates an oriented photoactive material including oriented PCCN in nanorod configuration on substrate, according to an embodiment.

FIG. 8 shows light polarization method, according to an embodiment.

FIG. 9 shows multiple mirror surface configuration, according to an embodiment.

FIG. 10 shows focusing mirror surfaces configuration, according to an embodiment.

FIG. 11 illustrates charge separation process that may occur during carbon dioxide reduction process, according to an embodiment.

FIG. 12 represents carbon dioxide reduction system, according to an embodiment.

### DETAILED DESCRIPTION

Reference will now be made in detail to the preferred embodiments, examples of which are illustrated in the accompanying drawings. The embodiments described above are intended to be exemplary. One skilled in the art recognizes that numerous alternative components and embodiments that may be substituted for the particular examples described herein and still fall within the scope of the invention.

A system for harvesting oriented light is disclosed. Disclosed system may include oriented photocatalytic semiconductor surfaces that may be used for a high efficiency harvesting light and, may be employed in carbon dioxide reduction.

In the following detailed description, reference is made to the accompanying drawings, which form a part hereof. In the drawings, which are not to scale or to proportion, similar symbols typically identify similar components, unless context dictates otherwise. The illustrative embodiments described in the detailed description, drawings and claims, are not meant to be limiting. Other embodiments may be used and/or and other changes may be made without departing from the spirit or scope of the present disclosure.

### DEFINITIONS

As used here, the following terms may have the following definitions:

“Seeded growth” refers to methods for growing nanocrystals in which a seed nanocrystal is used to initiate nanocrystal lattice growth and elongation.

“Electron-hole pairs” refers to charge carriers that are created when an electron acquires energy sufficient to move from a valence band to a conduction band and creates a free hole in the valence band, thus starting a process of charge separation.

“Semiconductor nanocrystals” refers to particles sized between about 1 and about 100 nanometers produced using semiconducting materials with high surface areas able to absorb light.

“Inorganic capping agent” refers to semiconductor particles that cap semiconductor nanocrystals.

“Orientation” refers to the rotation needed to bring a nanocrystal into position or alignment so that its longitudinal axis has a desired angle.

“Photoactive material” may refer to a substance that may be used in photocatalytic processes for absorbing light and starting a chemical reaction with light.

“Polarization” refers to a process in which waves of light are restricted to certain directions of vibration.

“Substantially oriented nanostructures” or “substantially non-randomly oriented nanostructures” refers to sets or clusters of nanostructures in which at least 10%, at least 25%, at least 50%, at least 75%, at least 90% or more of the member nanostructures are oriented or positioned relative to a designated axis, plane, surface or three dimensional space.

“Substantially aligned” refers to a subset of oriented nanostructures, in which at least 10%, at least 25%, at least 50%, at least 75%, at least 90% or more of the member nanostructures are oriented or positioned in a co-axial or parallel relationship.

“Alignment ligand” refers to components that interact with one or more nanostructures and can be used to order, orient, and/or align the associated nanostructures.

“Array of nanostructures” refers to an assemblage of nanostructures.

“Matrix” refers to a material, often a polymeric material, into which a second material (e.g., a nanostructure) is embedded, surrounded, or otherwise associated.

“Crystalline” or “substantially crystalline” refers to long-range ordering across one or more dimensions of a nanostructure.

“Electric dipole moment” refers to the separation of positive and negative charge on a system.

“Transition dipole moment” refers to the axis of a system that may interact with light of a certain polarization

### DESCRIPTION OF DRAWINGS

The present disclosure describes systems for harvesting oriented light employing oriented photoactive materials that include oriented photocatalytic semiconductor surfaces. Additionally, the present disclosure provides methods for preparing oriented, aligned, or otherwise structurally ordered Photocatalytic Capped Colloidal Nanocrystals (PCCN) that may be used to form oriented photocatalytic semiconductor surfaces.

Controlling the orientation of PCCN on a suitable substrate may allow controlling different areas of the light spectrum in the same system, therefore, increasing the efficiency in the light harvesting process. A homogeneous orientation of PCCN upon a substrate may be achieved employing a variety of state of the art methods, such as template-driven seeded growth, electrical field or other appropriate orientation forces.

In one aspect, the present disclosure provides a plurality of structurally ordered PCCN in a matrix. In one embodiment, the structurally ordered PCCN may be substantially non-randomly oriented semiconductor nanocrystals. Optionally, the non-randomly oriented PCCN may be substantially aligned with respect to one another, and/or substantially aligned with a selected axis. For compositions that are associated with or otherwise proximal to a substrate, the axis can be selected to be oriented substantially perpendicular to the surface of the substrate, parallel to the surface, or at a selected angle (e.g., about 15°, 30°, 45°, 60°, or any other suitable angle) with respect to the surface.

The orientation of the PCCN may be along either one crystallographic axis (1D orientation), or orientation along two axes (2D orientation). Once orientation is fixed along two axes, the third axis may already be fixed for a rigid structure.

Substantially oriented PCCN may include sets of splayed or angularly-gathered sets of PCCN (e.g., star patterns of PCCN).

Method for Growing Oriented Semiconductor Nanocrystals

In an embodiment, semiconductor nanocrystals may be grown employing a known in the art method for template-driven seeded growth. In order to grow a semiconductor nanocrystal, a seed crystal may be freely dispersed in a suitable solution. The semiconductor nanocrystal could be deposited on a suitable substrate. In other embodiments, the semiconductor nanocrystal may be the substrate itself, so that the substrate may include the same semiconductor nanocrystal material as the intended semiconductor nanocrystal. Furthermore, the substrate may include another crystalline material with the proper crystal lattice structure, atomic spacing, and surface energy in order to promote further semiconductor nanocrystal growth. For example, GaSb has shown to be a suitable surface for semiconductor nanocrystal growth. As such, a GaSb single semiconductor nanocrystal surface may be used to seed the growth of a semiconductor nanocrystal. Molecular Beam Epitaxy (MBE), or Chemical Beam Epitaxy (CBE) may be employed in seed growth of semiconductor nanocrystals to allow the nanocrystal growth to be templated by the substrate semiconductor nanocrystal structure. Then, photocatalytic semiconductor nanocrystal layers may be grown on top of the aligned and oriented semiconductor nanocrystal.

The seeded growth method generally decreases the activation energy required for semiconductor nanocrystal growth, as well as other reaction parameters such as monomer concentration and reaction temperature. Additionally seeded growth method may allow a degree of control over deposition density, growth rate, and orientation dispersion to yield a highly uniform and oriented semiconductor nanocrystal surface with 2D and 3D orientation. During operation, reflection high energy electron diffraction (RHEED) may be used for monitoring the growth of the semiconductor nanocrystal layers.

The morphologies of semiconductor nanocrystals employed in the present disclosure may include nanorods, nanoplates, nanowires, dumbbell-like nanoparticles and dendritic nanomaterials, among others. Each morphology may include an additional variety of shapes such as spheres, cubes, tetrahedra (tetrapods), among others.

In other embodiments, PCCN may be grown and deposited forming oriented arrays on suitable substrates in order to form oriented photoactive materials.

Method for Forming Composition of Photocatalytic Capped Colloidal Nanocrystal (PCCN)

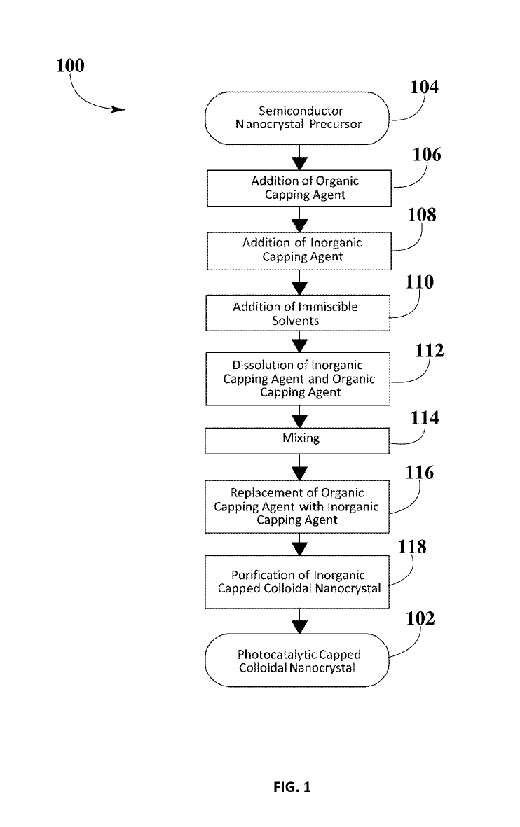

FIG. 1 shows a flow diagram of a method 100 for forming a composition of PCCN 102, according to an embodiment. PCCN 102 may be synthesized following accepted protocols, and may include one or more semiconductor nanocrystals and one or more inorganic capping agents.

Method 100 for forming a composition of PCCN 102 may include a first step where semiconductor nanocrystals may be grown by reacting as semiconductor nanocrystal 104 precursors in the presence of an organic solvent, here referred to as organic capping agent, by the addition of the organic capping agent 106. Additionally, the long organic chains radiating from organic capping agents on the surface of semiconductor nanocrystal 104 precursors may assist in the suspension and/or solubility of semiconductor nanocrystal 104 precursors in a solvent. The chemistry of capping agents may control several system parameters, for example, the size of semiconductor nanocrystal 104 precursors, growth rate or shape, the dispersability in various solvents and solids, and even the excited state lifetimes of charge carriers in semiconductor nanocrystal 104 precursors. The flexibility of synthesis is demonstrated by the fact that often one capping agent may be chosen for its growth control properties, and then later a different capping agent may be substituted to provide a more suitable interface or to modify optical properties or charge carrier mobility.

For the substitution of organic capping agents with inorganic capping agents, organic capped semiconductor nanocrystals 104 in the form of a powder, suspension, or a colloidal solution, may be mixed 114 by the addition of inorganic capping agents 108, causing a reaction of organic capped semiconductor nanocrystals 104 with inorganic capping agents. This reaction rapidly produces insoluble and intractable materials. Afterwards, an addition of immiscible solvents 110 may be made causing the dissolution of organic capping agents and inorganic capping agents 112. These two solutions may then be mixed 114, by combining and stirring them for about 10 minutes, after which a complete transfer of organic capped semiconductor nanocrystals 104 from the non-polar solvent to the polar solvent may be observed. During this exchange, organic capping agents are released. Generally, inorganic capping agents may be dissolved in a polar solvent, while organic capped semiconductor nanocrystals 104 may be dissolved in an immiscible, generally non-polar, solvent. The addition of immiscible solvents 110 may be made to control the reaction, facilitating a rapid and complete replacement of organic capping agents with inorganic capping agents 116

Organic capped semiconductor nanocrystals 104 may react with inorganic capping agents at or near the solvent boundary, where a portion of the organic capping agent may be exchanged/replaced with a portion of the inorganic capping agent. Thus, inorganic capping agents may displace organic capping agents from the surface of semiconductor nanocrystal 104 precursors, and inorganic capping agents may bind to that. This process continues until equilibrium is established between inorganic capping agents and the free inorganic capping agents. Preferably, the equilibrium favors inorganic capping agents. All the steps described above may be carried out in a nitrogen environment inside a glove box.

Subsequently, an isolation procedure, such as the precipitation of inorganic product, may be required for the purification of inorganic capped semiconductor nanocrystals 118 to form a PCCN 102. That precipitation permits one of ordinary skill to wash impurities and/or un-reacted materials out of the precipitate. Such isolation may allow for the selective application of PCCN 102.

Neither the morphology nor the size of semiconductor nanocrystal 104 precursors inhibits a method 100 for forming composition of PCCN 102 using the semiconductor nanocrystal 104 precursors; rather, the selection of morphology and size of semiconductor nanocrystal 104 precursors may permit the tuning and control of the properties of PCCN 102.

Examples of semiconductor nanocrystal 104 precursors may include the following: Ag, Au, Ru, Rh, Pt, Pd, Os, Ir, Ni, Cu, CdS, Pt-tipped, TiO₂, Mn/ZnO, ZnO, CdSe, SiO₂, ZrO₂, SnO₂, WO₃, MoO₃, CeO₂, ZnS, WS₂, MoS₂, SiC, GaP, Cu—Au, Ag, and mixtures thereof; Cu/TiO2, Ag/TiO₂, Cu—Fe/TiO₂—SiO₂ and dye-sensitized Cu—Fe/P25 coated optical fibers, AlN, AlP, AlAs, Bi, Bi₂S₃, Bi₂Se₃, Bi₂Te₃, CdS, CdSe, CdTe, Co, CoPt, CoPt₃, Cu₂S, Cu₂Se, CuInSe₂, CuIn₍₁₋ₓ₎Gaₓ(S,Se)₂, Cu₂ZnSn(S,Se)₄, Fe, FeO, Fe₂O₃, Fe₃O₄, FePt, GaN, GaP, GaAs, GaSb, GaSe, Ge, HgS, HgSe, HgTe, InN, InP, InSb, InAs, Ni, PbS, PbSe, PbTe, Si, Sn, ZnSe, ZnTe, and mixtures thereof. Examples of applicable semiconductor nanocrystals 104 may include core/shell semiconductor nanocrystals 104 like Au/PbS, Au/PbSe, Au/PbTe, Ag/PbS, Ag/PbSe, Ag/PbTe, Pt/PbS, Pt/PbSe, Pt/PbTe, Au/CdS, Au/CdSe, Au/CdTe, Ag/CdS, Ag/CdSe, Ag/CdTe, Pt/CdS, Pt/CdSe, Pt/CdTe, Au/FeO, Au/Fe₂O₃, Au/Fe₃O4, Pt/FeO, Pt/Fe₂O₃, Pt/Fe₃O₄, FePt/PbS, FePt/PbSe, FePt/PbTe, FePt/CdS, FePt/CdSe, FePt/CdTe, CdSe/CdS, CdSe/ZnS, InP/CdSe, InP/ZnS, InP/ZnSe, InAs/CdSe, and InAs/ZnSe; nanorods like CdSe, core/shell nanorods like CdSe/CdS; nano-tetrapods like CdTe, and core/shell nano-tetrapods like CdSe/CdS.

The organic solvent may be a stabilizing organic ligand. One example of an organic capping agent may be trioctylphosphine oxide (TOPO). TOPO 99% may be obtained from Sigma-Aldrich Co. LLC (St. Louis, Mo.). TOPO capping agent prevents the agglomeration of semiconductor nanocrystals during and after their synthesis. Other suitable organic capping agents may include long-chain aliphatic amines, long-chain aliphatic phosphines, long-chain aliphatic carboxylic acids, long-chain aliphatic phosphonic acids and mixtures thereof.

Some examples of polar solvents may include 1,3-butanediol, acetonitrile, ammonia, benzonitrile, butanol, dimethylacetamide, dimethylamine, dimethylethylenediamine, dimethylformamide, dimethylsulfoxide (DMSO), dioxane, ethanol, ethanolamine, ethylenediamine, ethyleneglycol, formamide (FA), glycerol, methanol, methoxyethanol, methylamine, methylformamide, methylpyrrolidinone, pyridine, tetramethylethylenediamine, triethylamine, trimethylamine, trimethylethylenediamine, water, and mixtures thereof. Polar solvents like FA, spectroscopy grade, and DMSO, anhydrous, 99.9% may be supplied by Sigma-Aldrich Co. LLC. Suitable colloidal stability of the dispersions of semiconductor nanocrystal 104 precursors is mainly determined by a solvent dielectric constant, which may range between about 106 to about 47, with about 106 being preferred.

Examples of non-polar or organic solvents may include tertiary-Butanol, pentane, pentanes, cyclopentane, hexane, hexanes, cyclohexane, heptane, octane, isooctane, nonane, decane, dodecane, hexadecane, benzene, 2,2,4-trimethylpentane, toluene, petroleum ether, ethyl acetate, diisopropyl ether, diethyl ether, carbon tetrachloride, carbon disulfide, and mixtures thereof. Other examples may include alcohol, hexadecylamine (HDA), hydrocarbon solvents at high temperatures.

Preferred inorganic capping agents for PCCN 102 may include chalcogenides, and zintl ions (homopolyatomic anions and heteropolyatomic anions that may have intermetallic bonds between the same or different metals of the main group, transition metals, lanthanides, and/or actinides, for example, As₃³⁻, As₄²⁻, As₅³⁻, As₇³⁻, Ae₁₁³⁻, AsS₃³⁻, As₂Se₆³⁻, As₂Te₆³⁻, As₁₀Te₃²⁻, Au₂Te₄²⁻, Au₃Te₄³⁻, Bi₃³⁻, Bi₄²⁻, Bi₅³⁻, GaTe²⁻, Ge₉²⁻, Ge₉⁴⁻, Ge₂S₆⁴⁻, HgSe₂²⁻, Hg₃Se₄²⁻, In₂Se₄²⁻, In₂Te₄²⁻, Ni₅Sb₁₇⁴⁻, Pb₅²⁻, Pb₇⁴⁻, Pb₉⁴⁻, Pb₂Sb₂²⁻, Sb₃³⁻Sb₄²⁻, Sb₇³⁻, SbSe₄³⁻, SbSe₄⁵⁻, SbTe₄⁵⁻, Sb₂Se₃⁻, Sb₂Te₅⁴⁻, Sb₂Te₇⁴⁻,Sb₄Te₄⁴⁻, Sb₉Te₆³⁻, Se₂²⁻, Se₃²⁻, Se₄²⁻, Se_{5,6}²⁻, Se₆²⁻, Sn₅²⁻, Sn₉³⁻, Sn₉⁴⁻, SnS₄⁴⁻, SnSe₄⁴⁻, SnTe₄⁴⁻, SnS₄Mn₂⁵⁻, SnS₂S₆⁴⁻, Sn₂Se₆⁴⁻, Sn₂Te₆⁴⁻, Sn₂Bi₂²⁻, Sn₈Sb³⁻, Te₂²⁻, Te₃²⁻, Te₄²⁻, Tl₂Te₂²⁻, TlSn₈³⁻, TlSn₈⁵⁻, TlSn₉³⁻, TlTe₂²⁻, mixed metal SnS₄Mn₂⁵⁻, and the like), where zintl ions refers to homopolyatomic anions and heteropolyatomic anions that have intermetallic bonds between the same or different metals of the main group, lanthanides, and/or actinides, transition metal chalcogenides, such as, tetrasulfides and tetraselenides of vanadium, niobium, tantalum, molybdenum, tungsten, and rhenium, and the tetratellurides of niobium, tantalum, and tungsten. These transition metal chalcogenides may further include the monometallic and polymetallic polysulfides, polyselenides, and mixtures thereof, e.g., MoS(Se₄)₂²⁻, Mo₂S₆²⁻, and the like, polyoxometalates and oxometalates, such as tungsten oxide, iron oxide, zinc oxide, cadmium oxide, zinc sulfide, gallium zinc nitride oxide, bismuth vanadium oxide, zinc oxide, and titanium dioxide, among others; metals selected from transition metals; positively charged counter ions, such as alkali metal ions, ammonium, hydrazinium, tetraalkylammmonium, and the like.

Further embodiments may include other inorganic capping agents. For example, inorganic capping agents may include molecular compounds derived from CuInSe₂, CuInₓGa₁₋ₓSe₂, Ga₂Se₃, In₂Se₃, In₂Te₃, Sb₂S₃, Sb₂Se₃, Sb₂Te₃, and ZnTe.

Method 100 may be adapted to produce a wide variety of PCCN 102. Adaptations of method 100 may include adding two different inorganic capping agents to a single semiconductor nanocrystal 104 precursor, adding two different semiconductor nanocrystal 104 precursors to a single inorganic capping agent, adding two different semiconductor nanocrystal 104 precursors to two different inorganic capping agents, and/or additional multiplicities. The sequential addition of inorganic capping agents 108 to semiconductor nanocrystal 104 precursors may be possible under the disclosed method 100. Depending, for example, upon concentration, nucleophilicity, bond strength between capping agents and semiconductor nanocrystal 104 precursor, and bond strength between semiconductor nanocrystal 104 precursor face dependent capping agent and semiconductor nanocrystal 104 precursor, inorganic capping of semiconductor nanocrystal 104 precursor may be manipulated to yield other combinations.

Suitable PCCN 102 may include ZnS.TiO₂, TiO₂.CuO, ZnS.RuOₓ, ZnS.ReOₓ, Au.AsS₃, Au.Sn₂S₆, Au.SnS₄, Au.Sn₂Se₆, Au.In₂Se₄, Bi₂S₃.Sb₂Te₅, Bi₂S₃.Sb₂Te₇, Bi₂Se₃.Sb₂Te₅, Bi₂Se₃.Sb₂Te₇, CdSe.Sn₂S₆, CdSe.Sn₂Te₆, CdSe.In₂Se₄, CdSe.Ge₂S₆, CdSe.Ge₂Se₃, CdSe.HgSe₂, CdSe.ZnTe, CdSe.Sb₂S₃, CdSe.SbSe₄, CdSe.Sb₂Te₇, CdSe.In₂Te₃, CdTe.Sn₂S₆, CdTe.Sn₂Te₆, CdTe.In₂Se₄, Au/PbS.Sn₂S₆, Au/PbSe.Sn₂S₆, Au/PbTe.Sn₂S₆, Au/CdS.Sn₂S₆, Au/CdSe.Sn₂S₆, Au/CdTe.Sn₂S₆, FePt/PbS.Sn₂S₆, FePt/PbSe.Sn₂S₆, FePt/PbTe.Sn₂S₆, FePt/CdS.Sn₂S₆, FePt/CdSe.Sn₂S₆, FePt/CdTe.Sn₂S₆, Au/PbS.SnS₄, Au/PbSe.SnS₄, Au/PbTe.SnS₄, Au/CdS.SnS₄, Au/CdSe.SnS₄, Au/CdTe.SnS₄, FePt/PbS.SnS₄FePt/PbSe.SnS₄, FePt/PbTe.SnS₄, FePt/CdS.SnS₄, FePt/CdSe.SnS₄, FePt/CdTe.SnS₄, Au/PbS.In₂Se₄Au/PbSe.In₂Se₄, Au/PbTe.In₂Se₄, Au/CdS.In₂Se₄, Au/CdSe.In₂Se₄, Au/CdTe.In₂Se₄, FePt/PbS.In₂Se₄FePt/PbSe.In₂Se₄, FePt/PbTe.In₂Se₄, FePt/CdS.In₂Se₄, FePt/CdSe.In₂Se₄, FePt/CdTe.In₂Se₄, CdSe/CdS.Sn₂S₆, CdSe/CdS.SnS₄, CdSe/ZnS.SnS₄,CdSe/CdS.Ge₂S₆, CdSe/CdS.In₂Se₄, CdSe/ZnS.In₂Se₄, Cu.In₂Se₄, Cu₂Se.Sn₂S₆, Pd.AsS₃, PbS.SnS₄, PbS.Sn₂S₆, PbS.Sn₂Se₆, PbS.In₂Se₄, PbS.Sn₂Te₆, PbS.AsS₃, ZnSe.Sn₂S₆, ZnSe.SnS₄, ZnS.Sn₂S₆, and ZnS.SnS₄ among others.

As used here the denotation ZnS.TiO₂ may refer to ZnS semiconductor nanocrystal 104 capped with TiO₂ inorganic capping agent. Charges on inorganic capping agent are omitted for clarity. This nomenclature [semiconductor nanocrystal].[inorganic capping agent] is used throughout this description. The specific percentages of semiconductor nanocrystal 104 precursors and inorganic capping agent may vary between different types of PCCN 102.

PCCN Structures

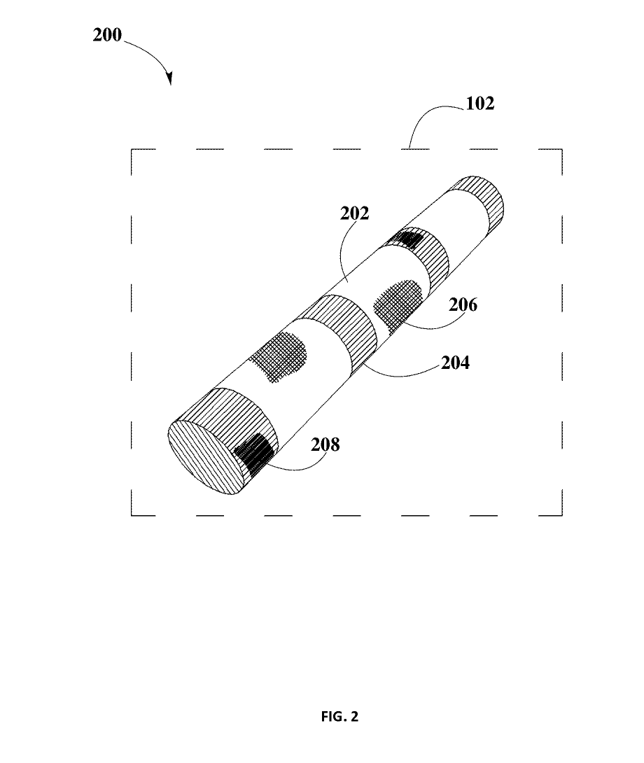

FIG. 2 shows an embodiment of PCCN 102 in nanorod configuration 200. According to an embodiment, there may be three ZnS regions and four Cu regions as first semiconductor nanocrystal 202 and second semiconductor nanocrystal 204, respectively, where the three first semiconductor nanocrystal 202 may be larger than each of the four second semiconductor nanocrystal 204 of nanorod configuration 200. In other embodiments, the different regions with different materials may have the same lengths, and there can be any suitable number of different regions. The number of regions per nanorod superlattice in nanorod configuration 200 may vary according to the length of the nanorod.

First semiconductor nanocrystal 202 and second semiconductor nanocrystal 204 may be capped with first inorganic capping agent 206 and second inorganic capping agent 208, respectively. First inorganic capping agent 206 may include ReO₂, while W₂O₃ may be employed as second inorganic capping agent 208. Second semiconductor nanocrystal 204 may be placed at the end points of nanorod configuration 200.

Other suitable configurations for PCCN 102 may be carbon nanotube, nanowire, nanospring, nanodentritic, spherical, tetrapod, core/shell and graphene sheets configuration, among others.

In order for light 602 to be absorbed by PCCN 102, light 602 should have suitable orientation relative to PCCN 102 and have a non-zero component of PCCN 102 electric field vector in line with transition dipole moment (TDM) of PCCN 102.

Alignment Process for Forming Oriented Photoactive Material.

When PCCN 102 interacts with an electromagnetic wave of frequency, PCCN 102 may undergo a transition from an initial to a final state of energy difference through the coupling of the electromagnetic field to the TDM. The process of single photon absorption is characterized by the TDM. The TDM is a vector and has to do with the differences in PCCN 102 electric charge distribution between an initial and final state. When this transition is from a lower energy state to a higher energy state, a photon may be absorbed. Moreover, a transition from a higher energy state to a lower energy state within PCCN 102 molecules, results in the emission of a photon.

The TDM may describe in which direction the electric charge within a PCCN 102 shifts during absorption of a photon. The amplitude of TDM is the transition moment between the initial (i) and final (f) states, and may be calculated as <|V|i>, where “f” may be the wave function of the final state of PCCN 102, “i” may be the wave function of the initial state of PCCN 102, “V” may be the disturbance or TDM=mu*E (where “mu” may be the dipole moment of PCCN 102 in initial state, and “E” may be the electric part of the electromagnetic field). V is the electric dipole moment (EDM) operator, a vector operator that is the sum of the position vectors of all charged particles weighed with their charge.

The TDM direction in PCCN 102 defines the direction of transition polarization, and the TDM square determines the strength of the transition.

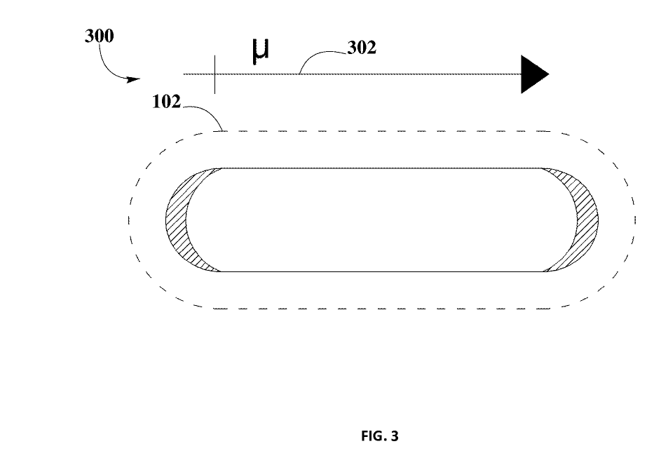

FIG. 3 illustrates transition dipole moment characterization 300 within PCCN 102 in nanorod configuration 200, according to an embodiment. FIG. 3 shows the axis of PCCN 102 along which electrons within PCCN 102 interact with the electromagnetic field of an incident photon. The TDM 302 relates the interaction of PCCN 102 to the polarization of incident light.

TDM 302 is a vector in the PCCN 102 molecular framework, characterized both by its direction and its probability. The absorption probability for linearly polarized light is proportional to the cosine square of the angle between the electric vector of the electromagnetic wave and TDM 302; light absorption may be maximized if they are parallel, and no absorption may occur if they are perpendicular.

Therefore, by controlling the orientation of PCCN 102 employed in the disclosed photocatalytic system for harvesting oriented light, an increase in the efficiency of light absorption and hence, an increase in the energy conversion, may be achieved. For this purpose oriented photoactive materials may be formed applying orientation forces to PCCN 102 during deposition and/or after they are deposited onto a suitable substrate.

When a non-uniform electric field is applied to a medium including PCCN 102, an electric dipole may be induced to generate dielectrophoresis, which may attract and orient PCCN 102 in a single direction or angle. In an embodiment, synthesized PCCN 102 may be diluted on a suitable dielectric solvent. A drop of the suspension form from the dilution with the dielectric solvent may then be placed on a suitable substrate where an electric field may be applied. The PCCN 102 in the solution may then be attracted and assembled on the substrate. Then, the dielectric solvent may be evaporated in air because heavy molecular weight dielectric solvents may be removed at high temperature.

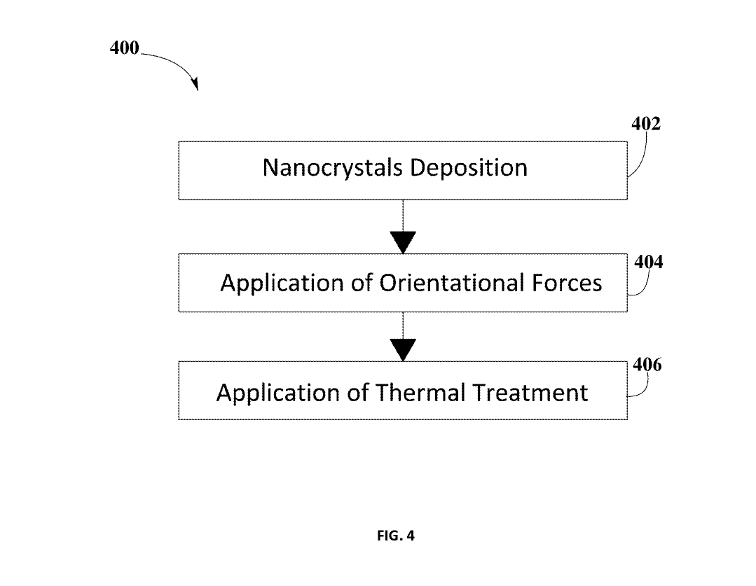

FIG. 4 is a flowchart of alignment method 400 for forming oriented photocatalytic semiconductor surfaces, according to an embodiment. Alignment method 400 for forming oriented photocatalytic semiconductor surfaces, may include deposition 402 of PCCN 102 on a substrate. PCCN 102 may be deposited on a suitable substrate employing known in the art deposition methods such as spraying deposition and annealing methods that may be used to apply and thermally treat semiconductor nanocrystals 104 on a substrate.

In another embodiment, semiconductor nanocrystals 104 may be deposited and thermally treated on a suitable substrate, employing known in the art suitable methods (e.g. spraying deposition and annealing methods). For these methods, suitable substrates may include non-porous substrates and porous substrates, which may additionally be optically transparent in order to allow PCCN to receive more light. Suitable non-porous substrates may include polydiallyldimethylammonium chloride (PDDA), polyethylene terephthalate (PET), and silicon, while suitable porous substrates may include glass frits, fiberglass cloth, porous alumina, and porous silicon. Suitable porous substrates may additionally exhibit a pore size sufficient for a gas to pass through at a constant flow rate. Suitable substrates may be planar or parabolic, individually controlled planar plates, or a grid work of plates.

Optionally, the position or orientation of semiconductor nanocrystals 104 or PCCN 102 may be selected such that clusters of semiconductor nanocrystals 104 or PCCN 102 are tuned; this may be achieved, e.g., by selecting an appropriate atom geometry and/or chemical composition.

Other deposition methods of semiconductor nanocrystals 104 or PCCN 102 may include plating, chemical synthesis in solution, chemical vapor deposition (CVD), spin coating, plasma enhanced chemical vapor deposition (PECVD), laser ablation, thermal evaporation, molecular beam epitaxy (MBE), electron beam evaporation, pulsed laser deposition (PLD), sputtering, reactive sputtering, atomic layer deposition, sputter deposition, reverse Lang-muir-Blodgett technique, electrostatic deposition, spin coating, inkjet deposition, laser printing (matrices), among others.

Subsequently, an application of orientation forces 404 may be added to PCCN 102. Afterwards, PCCN 102 may pass through a thermal treatment 406 employing a convection heater, with temperatures less than between about 200° C. to about 350° C., to produce crystalline films from the PCCN 102. Thermal treatment 406 may yield, for example, ordered arrays of PCCN 102 within an inorganic matrix, hetero-alloys, or alloys.

In one embodiment, application of orientation forces 404 may be achieved by employing an alignment process.

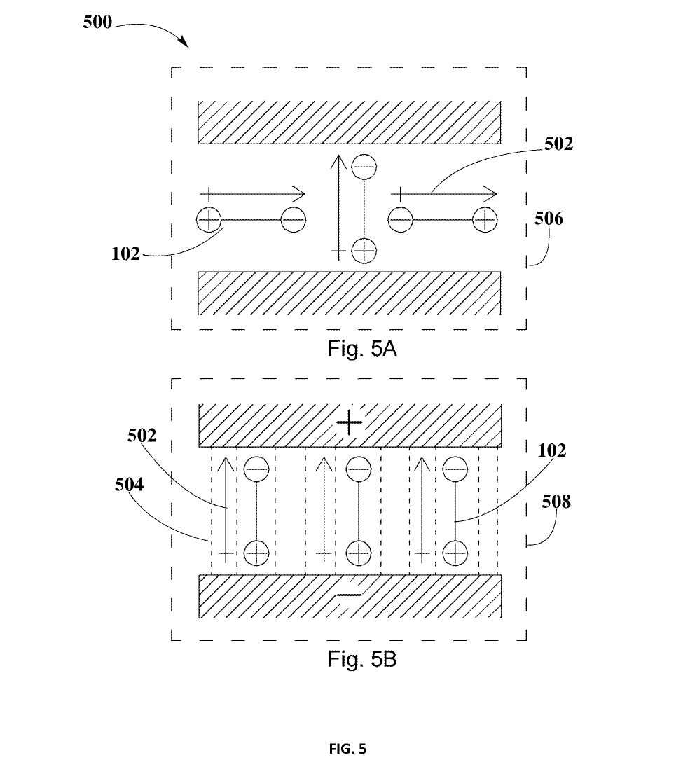

FIG. 5 depicts alignment process 500 employing electric fields, depicted by electric field lines 504, which might be an example of application of orientation forces 404.

In an embodiment, photoactive material 506, including PCCN 102, may be exposed to an external electric field. EDM 502 of PCCN 102 may interact with the external electric field, causing PCCN 102 to rotate in such a way that the energy of EDM 502 in external electric field may be minimized. In many cases, this means that EDM 502 of PCCN 102 may be parallel to electric field lines 504 and form an oriented photoactive material 508 which may be employed as an oriented photocatalytic semiconductor surface that may allow to predict the polarity of the light, for a more efficient interaction with oriented photoactive material 508 and increase the light harvesting efficiency. EDM 502 of the nanocrystals is along the same axis, the rods are oriented in the same angle on the substrate, all in the same orientation.

According to an embodiment, alignment process 500 may be controlled using charged ligands within PCCN 102 as well as EDM 502.

In an embodiment, application of orientation forces 404 may include known in the art molecular combing deposition technique, which consists of slowly wicking away solvent of the solution including the PCCN 102 to be deposited, so that at the meniscus interface, PCCN 102 experience a directional force along the direction of the wicking action.

In another embodiment, photoactive material 506 may pass through a surface charge. Some of the faces of PCCN 102 may be ionic in nature and by having a charged substrates it may be possible to pre-define which face or faces of PCCN 102 interact or are attached to the substrate during deposition. Cationic faces may be attracted to negatively charged substrates and anionic faces may be attracted towards positively charged substrates. For example, in PCCN 102 including Cd²⁺ or Zn²⁺, are generally cationic in nature and a negatively-charged substrates may preferentially attract these cationic semiconductor nanocrystal 104 faces, resulting in some degree of orientation of PCCN 102.

In yet another embodiment, oriented photoactive material 508 may include a Langmuir Blodgett film, which may be formed by employing Langmuir Blodgett method, resulting in the alignment of a thin film monolayer of PCCN 102 along 2 axes. (1D or 2D orientation).

Employing the Langmuir Blodgett method a PCCN 102 monolayer may be formed on a water surface by compression and subsequently PCCN 102 monolayer may be transferred onto a suitable substrate by a controlled removal of the water sub-phase.

In an embodiment, oriented photoactive material 508 may include surface-ligands. By controlling the ligands on the surface of PCCN 102 and ligands on the surface of the deposition substrate, specific orientations of the PCCN 102 to the substrate may be engineered.

PCCN 102 may include one or more alignment ligands associated with PCCN 102. The structurally ordering of the plurality of PCCN 102 may be achieved by interacting a first alignment ligand on a first PCCN 102 with a second alignment ligand on an adjacent PCCN 102. Generally the first and second alignment ligands may be complementary binding pairs. Optionally, both complements of the binding pair are provided on the same molecule (e.g., a multifunctional molecule). In some embodiments, a single chemical entity can be used as the first and second alignment ligands. Alternatively, the two halves of the complementary binding pair may be provided on different compositions, such that the first and second alignment ligands are differing molecules.

Interacting the first and second alignment ligands to achieve the selective orientation of the plurality of PCCN 102, can be performed, for example, by heating and cooling the plurality of PCCN 102. In embodiments in which the first and second alignment ligands further include a crosslinking or polymerizable element, interacting the alignment ligands may include crosslinking or polymerizing the first and second alignment ligands, e.g., to form a matrix.

As a further embodiment, the plurality of selectively-oriented PCCN 102 may be affixed to a substrate or surface. Optionally, the first and second alignment ligands may be removed after affixing the aligned PCCN 102, to produce a plurality of selectively-oriented PCCN 102 on a substrate.

After alignment process 500, oriented photoactive material 508 may then be cut into films to be used in energy conversion applications, such as carbon dioxide reduction.

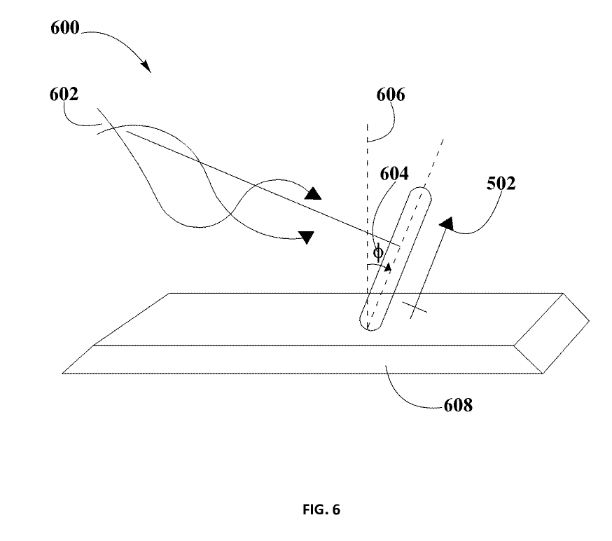

FIG. 6 depicts an embodiment of oriented PCCN 600 in nanorod configuration 200 showing oriented EDM 502 receiving light 602. EDM 502 of oriented PCCN 600 may be oriented at a fi angle 604 from a normal axis 606 to the upper surface of substrate 608 onto which PCCN 102 has been deposited.

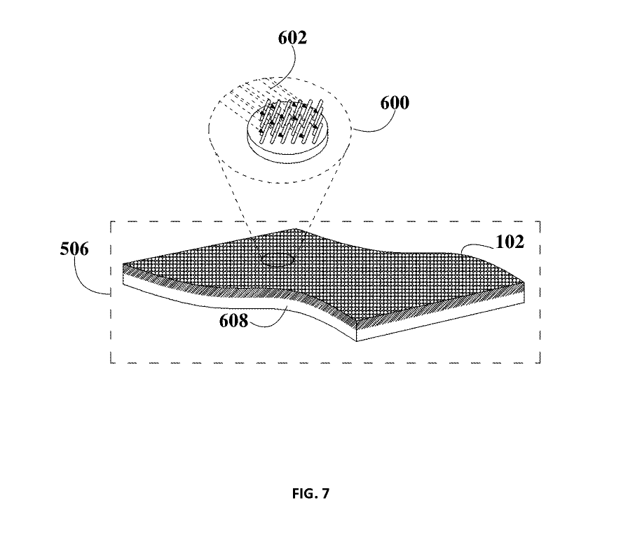

FIG. 7 illustrates an embodiment of oriented photoactive material 508, including oriented PCCN 600 in nanorod configuration 200 on substrate 608. Oriented PCCN 600 in oriented photoactive material 508 may also exhibit carbon nanotube, nanosprings, and nanowire configuration, among others.

Performance of oriented photoactive material 508 may be related to light 602 absorbance, charge carriers mobility and energy conversion efficiency. In order to measure the performance of oriented photoactive material 508, devices such as transmission electron microscopy (TEM), and energy dispersive X-ray (EDX), among others, may be utilized. Additionally, the size, shape and local ordering of oriented PCCN 600 arrays may be studied by a scanning electron microscope (Leo 1550 HR SEM).

Another aspect of the present disclosure includes light 602 polarization systems that may be employed within the disclosed system for harvesting oriented light 602 for carbon dioxide reduction.

Light Polarization System

In one embodiment, partial linear polarization of light 602 may be achieved after reflecting off a single mirror surface, so at least one mirror surface may be necessary to achieve polarization.

In some embodiments, more than one mirror surface may be used to best guide the incident light 602 to focus on oriented photoactive material 508. To achieve linearly-polarized light 602, the first, polarizing mirror surface may be kept at Brewster's angle relative to the direction of the sun. In some embodiments, the mirror surface may have a thin glass layer on top, which may serve as a protective layer to the reflective metal surface. The protective glass layer may be thin enough, to avoid undesired optical interference.

Additionally, the system may include a sun-tracking system that allows the mirror surfaces collecting incident light 602 to be always at Brewster's angle relative to the sun. The addition of the sun tracking system may allow the optimal recollection of sunlight at all times.

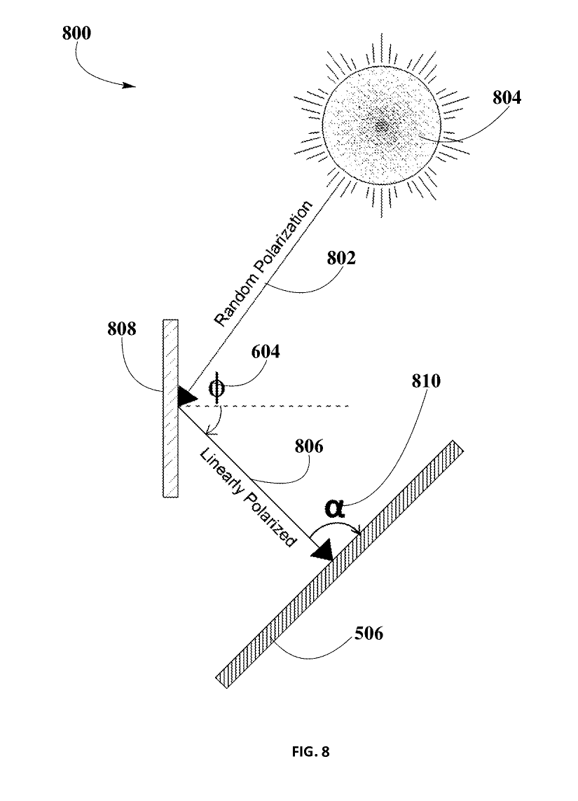

FIG. 8 shows light polarization system 800. Randomly polarized incident light 802 irradiated by light source 804, which may be sunlight, may become linearly polarized light 806 if randomly polarized incident light 802 makes contact with the surface of a reflective device such as a mirror surface 808 at a fi angle 604 which is equivalent to the Brewster's angle of incidence of mirror surface 808. Oriented photoactive material 508 may be positioned in such a way that alpha angle 810, at which linearly polarized light 806 reaches oriented photoactive material 508, allows the optimal absorption of linearly polarized light 806. A sun tracking system may be used to keep fi angle 604 and alpha angle 810 in a suitable range, such that maximum efficiency may be achieved at all times.

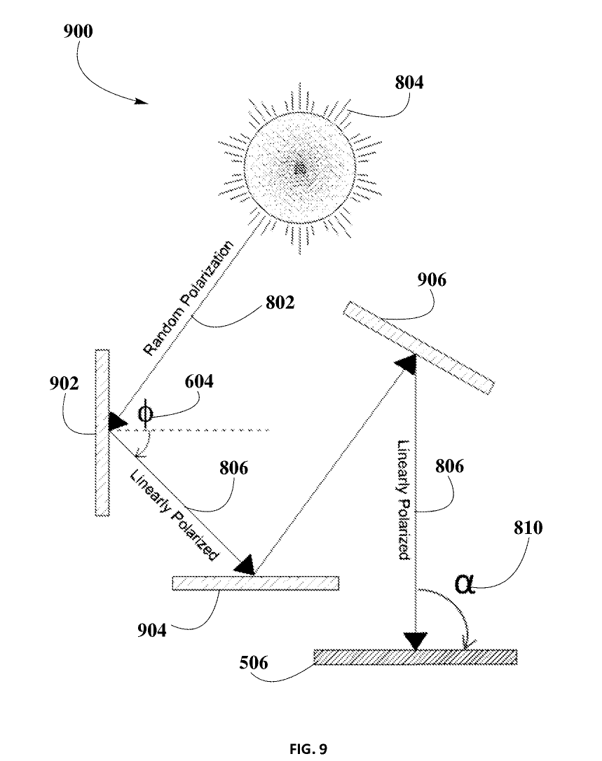

FIG. 9 shows multiple mirror surface configuration 900, which may be an embodiment of light polarization system 800. Randomly polarized incident light 802 may be collected by tracking mirror surface 902, which tracks the movement of light source 804 to collect and polarize sunlight, maintaining fi angle 604 equal to Brewster's angle of incidence. Then, first steering mirror surface 904 and second steering mirror surface 906 may direct linearly polarized light 806 towards oriented photoactive material 508 at the optimum alpha angle 810 of incidence. First steering mirror surface 904 and second steering mirror surface 906 may be capable of changing their relative position in order to ensure that at all times alpha angle 810 is maintained at optimal or preferred values. By the addition of first steering mirror surface 904 and second steering mirror surface 906 oriented photoactive material 508 may remain in a fixed position.

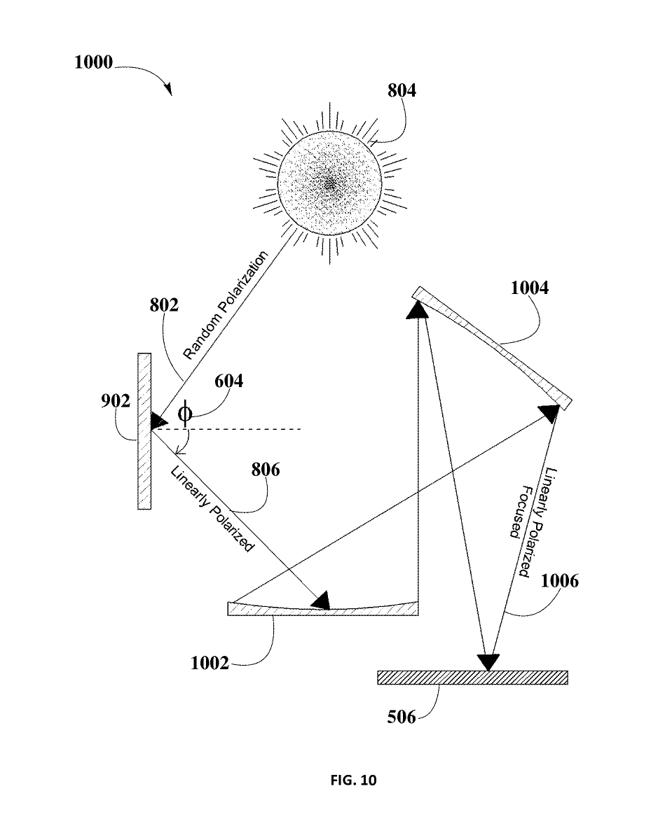

FIG. 10 shows focusing mirror surface configuration 1000, which may be an embodiment of light polarization system 800. In an embodiment, randomly polarized incident light 802 may be collected by tracking mirror surface 902, which tracks the movement of light source 804 to collect and polarize sunlight, maintaining fi angle 604 equal to Brewster's angle of incidence. Then first focusing steering mirror surface 1002 and second focusing steering mirror surface 1004 may direct focused linearly polarized light 1006 towards oriented photoactive material 508. By focusing linearly polarized light 806 photocatalytic system efficiency may be increased by decreasing the active surface of oriented photoactive material 508 needed for the carbon dioxide reduction.

Light polarization systems 800 disclosed may be employed to polarize sunlight to collect solar energy and orient light 602 rays for maximum absorption and energy conversion on oriented photoactive materials 508 in order to reduce carbon dioxide and produce methane and water.

Photocatalyst System Configuration and Functioning

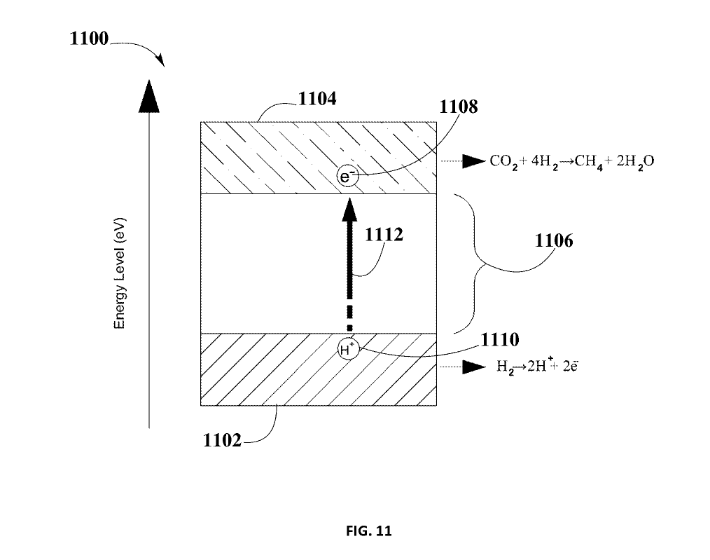

FIG. 11 illustrates charge separation process 1100 that may occur during carbon dioxide reduction process.

Band gap 1106 of semiconductor nanocrystals 104 should be large enough to drive carbon dioxide reduction reactions but small enough to absorb a large fraction of light 602 wavelengths. Band gap 1106 of PCCN 102 employed in the reduction of carbon dioxide should be at least 1.33 eV, which corresponds to absorption of solar photons of wavelengths below 930 nm. Considering the energy loss associated with entropy change (87 J/mol·K) and other losses involved in carbon dioxide reduction (forming methane and water vapor), band gap 1106 between about 2 and about 2.4 eV may be preferred. The manifestation of band gap 1106 in optical absorption is that only photons with energy larger than or equal to band gap 1106 are absorbed.

Electrons 1108 may acquire energy corresponding to the wavelength of absorbed light 602. Upon being excited, electrons 1108 may relax to the bottom of conduction band 1104, which may lead to recombination with holes 1110 and, therefore, to an inefficient charge separation process 1100.

According to one embodiment, to achieve an charge separation process 1100, semiconductor nanocrystal 104 in oriented photoactive material 508 may be capped with first inorganic capping agent 206 and second inorganic capping agent 208 as a reduction photocatalyst and an oxidative photocatalyst, respectively. Following photo-excitation 1112 to conduction band 1104, electron 1108 can quickly move to the acceptor state of first inorganic capping agent 206 and hole 1110 can move to the donor state of second inorganic capping agent 208, preventing recombination of electrons 1108 and holes 1110. First inorganic capping agent 206 acceptor state and second inorganic capping agent 208 donor state lie energetically between the limits of band gap 1106 and the redox potentials of the hydrogen oxidation and carbon dioxide reduction reactions. By being more stable to recombination in the donor and acceptor states, charge carriers may be stored for use in redox reactions required for a more efficient charge separation process 1100, and hence, a more productive carbon dioxide reduction process.

When semiconductor nanocrystals 104 in oriented photoactive material 508 are irradiated with photons having a level of energy greater than band gap 1106 of oriented photoactive material 508, electrons 1108 may be excited from valence band 1102 into conduction band 1104, leaving holes 1110 behind in valence band 1102. Excited electrons 1108 may reduce carbon dioxide molecules into methane, while holes 1110 may oxidize hydrogen gas molecules. Oxidized hydrogen molecules may react with carbon dioxide and form water and methane via a series of reactions that may be summarized by the equations on table 1:

TABLE 1
Carbon dioxide reduction equations

| Equation | Product |
|---|---|
| CO₂ + 2H⁺ + 2e⁻ → HCOOH | Formic acid |
| COOH + 2H⁺ + 2e⁻ → HCHO + H₂O | Formaldehyde |
| HCHO + 2H⁺ + 2e⁻ → CH₃OH | Methanol |
| CH₃OH + 2H⁺ + 2e⁻ → CH₄ + H₂O | Methane |

According to table 1, in the carbon dioxide reduction process, carbon dioxide, in the presence of hydrogen, may be photo-catalytically reduced into methane and water. Electrons 1108 may be obtained from oriented photoactive material 508 and hydrogen atoms may be obtained from hydrogen gas. Beginning from adsorbed carbon dioxide, formic acid (HCOOH) may be formed by accepting two electrons 1108 and adding two hydrogen atoms. Then, formaldehyde (HCHO) and water molecules may be formed from the reduction of formic acid by accepting two electrons 1108 and adding two hydrogen atoms. Subsequently, methanol (CH₃OH) may be formed when formaldehyde accepts two electrons 1108 and two hydrogen atoms may be added to formaldehyde. Finally, methane may be formed when methanol accepts two electrons 1108 and two hydrogen atoms are added to methanol. In addition, water may be formed as a byproduct of the reaction.

The reduction of carbon dioxide to methane are required reducing the chemical state of carbon from C (4+) to C (4−). Eight electrons 1108 are required for the production of each methane. Taken as a whole, eight hydrogen atoms and eight electrons 1108 progressively transfer to one adsorbed carbon dioxide molecule resulting in the production of one methane molecule. Similarly, oxygen released from carbon dioxide may react with free hydrogen radicals and form water vapor molecules.

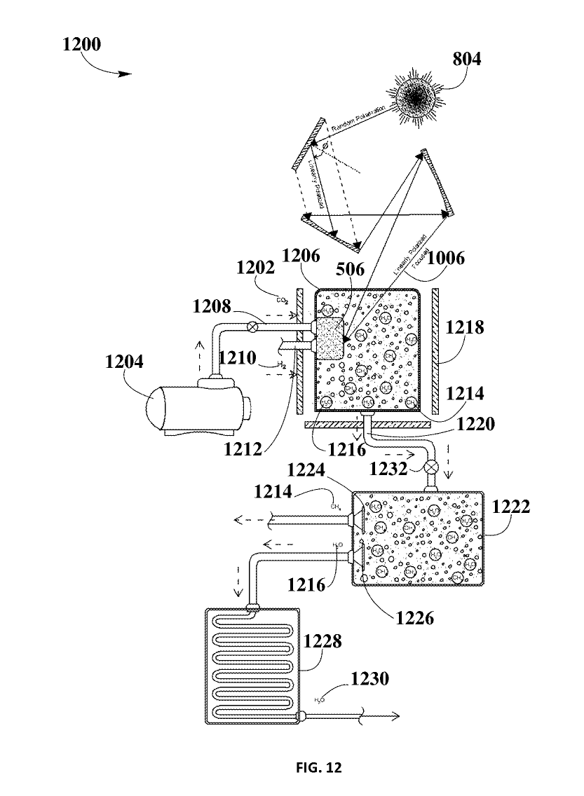

FIG. 12 represents carbon dioxide reduction system 1200. Carbon dioxide reduction system 1200 may operate in conjunction with a combustion system that produces carbon dioxide 1202 as a byproduct. This system may be employed to take advantage of carbon dioxide 1202 produced by one or more boilers 1204 during a manufacturing process. Boiler 1204 may be connected to reaction vessel 1206 by first inlet line 1208 to allow a continuous flow of carbon dioxide 1202 gas. Subsequently, carbon dioxide 1202 may pass through oriented photoactive material 508. Similarly, hydrogen gas 1210 may also be injected into reaction vessel 1206 via second inlet line 1212. Optionally, a heater (not shown) may be employed to increase the temperature in reaction vessel 1206.

Light 602 from light source 804 may be polarized by light polarization system 800. Light polarization system 800 may reflect randomly polarized incident light 802 and may direct focused linearly polarized light 1006 into reaction vessel 1206 through window that may be placed on top of reaction vessel 1206. Linearly polarized light 806 may react with oriented photoactive material 508 to produce charge separation (explained in FIG. 11) in the boundary of oriented photoactive material 508. Carbon dioxide 1202 may be reduced and hydrogen gas 1210 may be oxidized by a series of reactions until methane molecule 1214 and water vapor 1216 are produced.

According to various embodiments, one or more walls of reaction vessel 1206 may be formed of glass or other transparent material, so that focused linearly polarized light 1006 may enter reaction vessel 1206 to react with oriented photoactive material 508. Alternatively, reaction vessel 1206 may have one transparent side to allow focused linearly polarized light 1006 to enter, while the other sides may have a reflective interior surface to reflect the majority of the solar radiation.

Alternatively, a solar reflector 1218 may be positioned at the bottom or any side of reaction vessel 1206 to reflect focused linearly polarized light 1006 back to reaction vessel 1206 and re-utilize focused linearly polarized light 1006.

Following chemical reactions described in table 1, the produced methane molecule 1214 and water vapor 1216 may exit reaction vessel 1206 through outlet line 1220 and enter collector 1222, where a methane-permeable membrane 1224 and a water vapor permeable membrane 1226 may collect methane molecules 1214 and water vapor 1216, respectively. In one embodiment, the membranes may be a polymide resin membrane and a polydimethylsiloxane membrane, respectively. The collected methane molecules 1214 may be subsequently stored in any suitable storage medium, or it may be directly used as fuel by boiler 1204. The collected water vapor 1216 may be transferred to water condenser 1228 through outlet line 1220 to obtain liquid water 1230. Valves 1232 pumps or monitoring devices may be added in order to measure and regulate pressure and/or flow rate. The flow rate of carbon dioxide 1202 and hydrogen gas 1210 into reaction vessel 1206 may be adjusted depending on reaction time between carbon dioxide 1202, hydrogen gas 1210, and oriented photoactive material 508. Optionally, a gas sensor device (not shown) may be attached to collector 1222 to identify any methane molecule 1214 leakage. Liquid water 1230 may be employed for different purposes in the manufacturing process.

While various aspects and embodiments have been disclosed, other aspects and embodiments are contemplated. The various aspects and embodiments disclosed are for purposes of illustration and are not intended to be limiting, with the true scope and spirit being indicated by the following claims.

The embodiments described above are intended to be exemplary. One skilled in the art recognizes that numerous alternative components and embodiments that may be substituted for the particular examples described herein and still fall within the scope of the invention.

1. A method for reducing carbon dioxide comprising:
forming photocatalytic capped colloidal nanocrystals, wherein each photocatalytic capped colloidal nanocrystal includes a first semiconductor nanocrystal capped with a first inorganic capping agent;
depositing the formed photocatalytic capped colloidal nanocrystals onto a porous substrate;
orienting the photocatalytic capped colloidal nanocrystals;
absorbing irradiated light with an energy equal to or greater than the band gap of the semiconductor nanocrystals by the photocatalytic capped colloidal nanocrystals to create charge carriers in a conduction band of the photocatalytic capped colloidal nanocrystals and holes in a valence band of the photocatalytic capped colloidal nanocrystals;
reacting carbon dioxide and hydrogen with the photocatalytic capped colloidal nanocrystals so that the charge carriers in the conduction band reduce carbon dioxide into methane and the holes in the valence band oxidize the hydrogen into water vapor; and
collecting the methane and water using a methane permeable membrane and a water vapor-permeable membrane.

2. The method of claim 1, further comprising:
polarizing the irradiated light with at least one mirror before the photocatalytic capped colloidal nanocrystals absorb the irradiated light.

3. The method of claim 2, further comprising:
steering the at least one mirror so that the at least one mirror maintains Brewster's angle relative to the sun.

4. The method of claim 3, wherein the at least one mirror is steered using a sun tracking system.

5. The method of claim 3, wherein the at least one mirror is a focusing mirror.

6. The method of claim 3, further comprising:
steering a second mirror so that the polarized light is directed at the oriented photocatalytic capped colloidal nanocrystals at an angle that facilitates absorption.

7. The method of claim 1, wherein forming photocatalytic capped colloidal nanocrystals comprises:
growing semiconductor nanocrystals by employing a template-driven seeded growth method; and
capping the semiconductor nanocrystals with an inorganic capping agent in a polar solvent to form photocatalytic capped colloidal nanocrystals.

8. The method of claim 7, wherein growing semiconductor nanocrystals by employing the template-driven seeded growth method comprises:
depositing a seed crystal on a substrate; and
growing the semiconductor nanocrystal from the seed crystal using molecular beam epitaxy or chemical beam epitaxy so that the semiconductor nanocrystal grows according to the seed crystal's structure.

9. The method of claim 7, wherein capping the semiconductor nanocrystals with an inorganic capping agent in the polar solvent to form the photocatalytic capped colloidal nanocrystals comprises:
reacting semiconductor nanocrystals precursors in the presence of an organic capping agent to form organic capped semiconductor nanocrystals;
reacting the organic capped semiconductor nanocrystals with an inorganic capping agent;
adding immiscible solvents causing the dissolution of the organic capping agents and the inorganic capping agents so that organic caps on the semiconductor nanocrystals are replaced by inorganic caps to form inorganic capped semiconductor nanocrystals; and
performing an isolation procedure to purify the inorganic capped semiconductor nanocrystals and remove the organic capping agent.

10. The method of claim 1, wherein orienting the photocatalytic capped colloidal nanocrystals is performed by applying an electric field, and the direction of the electric field is substantially parallel with an electric dipole moment of the photocatalytic capped colloidal nanocrystals.

11. The method of claim 4, wherein the photocatalytic capped colloidal nanocrystals include charged ligands that assist in controlling the orientation of the photocatalytic capped colloidal nanocrystals.

12. The method of claim 1, wherein orienting the photocatalytic capped colloidal nanocrystals is performed by a combing deposition technique.

13. The method of claim 1, wherein orienting the photocatalytic capped colloidal nanocrystals is performed by employing a Langmuir Blodgett method to form a Langmuir Blodgett film.

14. The method of claim 1, wherein the photocatalytic capped colloidal nanocrystals comprises a compound selected from a group consisting of ZnS.TiO₂, TiO₂.CuO, ZnS.RuOₓ, ZnS.ReOₓ, Au.AsS₃, Au.Sn₂S₆, Au.SnS₄, Au.Sn₂Se₆, Au.In₂Se₄, Bi₂S₃.Sb₂Te₅, Bi₂S₃.Sb₂Te₇, Bi₂Se₃.Sb₂Te₅, Bi₂Se₃.Sb₂Te₇, CdSe.Sn₂S₆, CdSe.Sn₂Te₆, CdSe.In₂Se₄, CdSe.Ge₂S₆, CdSe.Ge₂Se₃, CdSe.HgSe₂, CdSe.ZnTe, CdSe.Sb₂S₃, CdSe.SbSe₄, CdSe.Sb₂Te₇, CdSe.In₂Te₃, CdTe.Sn₂S₆, CdTe.Sn₂Te₆, CdTe.In₂Se₄, Au/PbS.Sn₂S₆, Au/PbSe.Sn₂S₆, Au/PbTe.Sn₂S₆, Au/CdS.Sn₂S₆, Au/CdSe.Sn₂S₆, Au/CdTe.Sn₂S₆, FePt/PbS.Sn₂S₆, FePt/PbSe.Sn₂S₆, FePt/PbTe.Sn₂S₆, FePt/CdS.Sn₂S₆, FePt/CdSe.Sn₂S₆, FePt/CdTe.Sn₂S₆, Au/PbS.SnS₄, Au/PbSe.SnS₄, Au/PbTe.SnS₄, Au/CdS.SnS₄, Au/CdSe.SnS₄, Au/CdTe.SnS₄, FePt/PbS.SnS₄FePt/PbSe.SnS₄, FePt/PbTe.SnS₄, FePt/CdS.SnS₄, FePt/CdSe.SnS₄, FePt/CdTe.SnS₄, Au/PbS.In₂Se₄Au/PbSe.In₂Se₄, Au/PbTe.In₂Se₄, Au/CdS.In₂Se₄, Au/CdSe.In₂Se₄, Au/CdTe.In₂Se₄, FePt/PbS.In₂Se₄FePt/PbSe.In₂Se₄, FePt/PbTe.In₂Se₄, FePt/CdS.In₂Se₄, FePt/CdSe.In₂Se₄, FePt/CdTe.In₂Se₄, CdSe/CdS.Sn₂S₆, CdSe/CdS.SnS₄, CdSe/ZnS.SnS₄, CdSe/CdS.Ge₂S₆, CdSe/CdS.In₂Se₄, CdSe/ZnS.In₂Se₄, Cu.In₂Se₄, Cu₂Se.Sn₂S₆, Pd.AsS₃, PbS.SnS₄, PbS.Sn₂S₆, PbS.Sn₂Se₆, PbS.In₂Se₄, PbS.Sn₂Te₆, PbS.AsS₃, ZnSe.Sn₂S₆, ZnSe.SnS₄, ZnS.Sn₂S₆, and ZnS.SnS₄.

15. The method of claim 1, wherein a shape of the photocatalytic capped colloidal nanocrystals is chosen based on a desired wavelength of the irradiated light usable by the semiconductor nanocrystals.

16. The method of claim 1, wherein the substrate has a pore size sufficient to admit carbon dioxide and hydrogen gas.

17. The method of claim 1, wherein carbon dioxide and hydrogen are reacted with the photocatalytic capped colloidal nanocrystals in a reaction vessel, further comprising heating the reaction vessel with a heater.

18. The method of claim 1, further comprising:
transferring the water vapor to a condenser through an outlet line to obtain liquid water.

19. The method of claim 1, wherein carbon dioxide and hydrogen are reacted with the photocatalytic capped colloidal nanocrystals in a reaction vessel, and wherein the carbon dioxide is produced by a combustion system that is connected to the reaction vessel.

20. The method of claim 19, further comprising:
transferring the methane to the combustion system so that the methane may be used as fuel for the combustion system.

21. The method of claim 1, wherein each photocatalytic capped colloidal nanocrystals includes a second semiconductor nanocrystal capped with a second inorganic capping agent, the first inorganic capping agent acts as a reduction photocatalyst, and the second inorganic capping agent acts as an oxidation photocatalyst.

22. The method of claim 1, wherein reducing carbon dioxide into methane and oxidizing the hydrogen into water vapor comprises:
forming formic acid by combining carbon dioxide, hydrogen, and two electrons;
forming formaldehyde and water by reducing the formic acid and adding two hydrogen atoms;
forming methanol by combining the formaldehyde, two hydrogen atoms, and two electrons; and
forming methane by having the methanol accept two electrons and adding two hydrogen atoms.

23. A carbon dioxide reduction system comprising:
an oriented photoactive material, wherein the oriented photoactive material includes oriented photocatalytic capped colloidal nanocrystals;
a reaction vessel housing the oriented photoactive material and configured to receive carbon dioxide from a first inlet, receive hydrogen from a second inlet, and facilitate a carbon dioxide reduction reaction and a hydrogen oxidization reaction that produces methane and water vapor, wherein the reaction begins when the photocatalytic capped colloidal nanocrystals absorb polarized light to separate charge carriers of the oriented photoactive material; and
a collector comprising a methane-permeable membrane and a water vapor permeable membrane and configured to receive the produced methane and water vapor from the reaction vessel through an outlet line and separate and collect the methane and water vapor using the methane-permeable membrane and the water vapor permeable membrane.

24. The carbon dioxide reduction system of claim 23, further comprising
a first mirror that collects and linearly polarizes the irradiated light irradiated by a light source.

25. The carbon dioxide reduction system of claim 24, further comprising:
a first steering mirror that direct the linearly polarized light received from the first mirror toward the oriented photoactive material at an optimum angle of incidence, wherein the optimum angle of incidence depends on the orientation of the photocatalytic capped colloidal nanocrystals.

26. The carbon dioxide reduction system of claim 24, wherein the first mirror is connected to a sun tracking system so that the first mirror receives sunlight at Brewster's angle.

27. The carbon dioxide reduction system of claim 24, wherein the first mirror is a focusing mirror.

28. The carbon dioxide reduction system of claim 23, further comprising:
a heater that heats the reaction vessel.

29. The carbon dioxide reduction system of claim 23, wherein the water vapor permeable membrane is a polydimethylsiloxane membrane.

30. The carbon dioxide reduction system of claim 23, wherein the methane-permeable membrane is a polymide resine membrane.

31. The carbon dioxide reduction system of claim 23, further comprising:
a valve that regulates pressure and flow rate of the carbon dioxide reduction system.

32. The carbon dioxide reduction system of claim 31, wherein the flow rate is adjusted depending on the reaction time between the carbon dioxide, hydrogen, and oriented photoactive material.

33. The carbon dioxide reduction system of claim 23, further comprising:
a solar reflector positioned within the reaction vessel such that irradiated light that is not absorbed by the oriented photoactive material is reflected back into the reaction vessel.

34. The carbon dioxide reduction system of claim 23, wherein the photocatalytic capped colloidal nanocrystals comprise a first semiconductor nanocrystal capped with a first inorganic capping agent.

35. The carbon dioxide reduction system of claim 33, wherein the photocatalytic capped colloidal nanocrystals further comprise a second semiconductor nanocrystal capped with a second inorganic capping agent.

36. The carbon dioxide reduction system of claim 34, wherein the first inorganic capping agent is a reduction photocatalyst and the second inorganic capping agent is an oxidation photocatalyst.

37. The carbon dioxide reduction system of claim 23, wherein at least a portion of the reaction vessel is formed of a transparent material.

38. The carbon dioxide reduction system of claim 23, further comprising:
a water condenser connected to the collector that receives the separated and collected water vapor and creates liquid water.

39. The carbon dioxide reduction system of claim 37, wherein the morphology of the photocatalytic capped colloidal nanocrystals comprise a morphology from a group consisting of a core/shell configuration, a nanowire configuration, or a nanospring configuration.

40. The carbon dioxide reduction system of claim 23, wherein the oriented photocatalytic capped colloidal nanocrystals are oriented by applying an electric field, and the direction of the electric field is substantially parallel with an electric dipole moment of the photocatalytic capped colloidal nanocrystals.

41. A carbon dioxide reduction system comprising:
an oriented photoactive material, wherein the oriented photoactive material includes oriented photocatalytic capped colloidal nanocrystals;
a boiler that produces carbon dioxide through a combustion reaction;
a reaction vessel housing the oriented photoactive material and configured to receive carbon dioxide from the boiler through a first inlet, receive hydrogen from a second inlet, and facilitate a carbon dioxide reduction reaction and a hydrogen oxidization reaction that produces methane and water vapor, wherein the reaction begins when the photocatalytic capped colloidal nanocrystals absorb polarized light to separate charge carriers of the oriented photoactive material; and
a collector comprising a methane-permeable membrane and a water vapor permeable membrane and configured to receive the produced methane and water vapor from the reaction vessel through an outlet line and separate and collect the methane and water vapor using the methane-permeable membrane and the water vapor permeable membrane.

42. The carbon dioxide reduction system of claim 40, wherein the carbon dioxide reduction reaction and hydrogen oxidization reaction further comprises:
forming formic acid by combining carbon dioxide, hydrogen, and two electrons;
forming formaldehyde and water by reducing the formic acid and adding two hydrogen atoms;
forming methanol by combining the formaldehyde, two hydrogen atoms, and two electrons; and
forming methane by having the methanol accept two electrons and adding two hydrogen atoms.
